(19) United States
(12) Patent Application Publication
(10) Pub. No.: US 2022/0256986 A1
(43) Pub. Date: Aug. 18, 2022

(54) Wearable Article for Display of Precious Stones

(71) Applicant: Darryl J. See, Hendersonville, NC (US)

(72) Inventor: Darryl J. See, Hendersonville, NC (US)

(21) Appl. No.: 17/501,652

(22) Filed: Oct. 14, 2021

Related U.S. Application Data
(63) Continuation-in-part of application No. 17/175,197, filed on Feb. 12, 2021.

(51) Int. Cl. A44C 15/00; A45C 15/06; A44C 17/02

(52) U.S. Cl. CPC A44C 15/0015; F21V 17/107; A44C 17/02; A45C 15/06

(57) ABSTRACT

Provided is a wearable device for displaying translucent stones and the like. The wearable device comprises a base, a back plate, a bezel and a locking element. The base comprises a cavity, at least one base locking element a recess comprising a recess void and an illumination assembly in the cavity wherein the illumination assembly comprises an illuminator capable of emitting light. The back plate is reversibly mountable on the base. The back plate comprises at least one back plate locking element. The back plate locking element is reversibly engageable with the base plate locking element. A tab is provided on the back plate which is receivable by the recess. The tab comprises a tab void which is alignable with the recess void. An illumination window in the back plate allows light to transmit through said illumination window. The back plate also comprises at least one securing recess and a paint preferably in an engraving. The bezel is reversibly mountable on the back plate. The bezel comprises a viewing window and a securing tab wherein the securing tab is received by the securing recess. A locking element extends through the aligned tab void and recess void.

### CROSS-REFERENCE TO RELATED APPLICATIONS

The present application is a continuation-in-part of pending U.S. patent application Ser. No. 17/175,197 filed Feb. 12, 2021 which is incorporated herein by reference.

### FIELD OF THE INVENTION

The present invention is related to a wearable article, such as a piece of jewelry, capable of reversibly engaging with a translucent precious stone such as a gem stone. More specifically, the present invention is related to a housing comprising a light source and a translucent precious stone mounting system wherein the stone can be easily replaced yet is secure when being worn.

### BACKGROUND

There has always been a desire to display natural elements of beauty as jewelry. Diamonds, sapphires, rubies and such have long adorned jewelry and clothing. Stones, particularly translucent stones, have been more difficult to display since their natural beauty is typically only evident in the presence of light and particularly light transmitting through the stone.

The availability of light emitting diodes (LED's) has generated a new interest in jewelry which can incorporate translucent stones since LED's are small, generate little heat, and can be powered by a small battery. Still the packaging required to contain the LED lights, electronics related thereto and a power source has resulted in heavy, unattractive articles. The difficulty in attaching a stone has also thwarted those attempting to provide a backlit translucent stone without risk of the stone becoming dislodged during wearing.

The present invention provides a wearable article which can have mounted thereto a translucent stone wherein the translucent stone is secure yet removable to allow for different stones to be used in different environments.

### SUMMARY OF THE INVENTION

The present invention is related to a wearable article suitable for displaying a backlit translucent stone which is reversibly mounted thereto.

More specifically, the present invention is related to a wearable article comprising an enclosed base wherein the base has secured thereto a backplate with a bezel secured to the backplate wherein the backplate and bezel reversibly engage with each other securing a translucent stone there between.

These and other embodiments, as will be realized, are provided in a wearable device. The wearable device comprises a base, a back plate, a bezel and a locking element. The base comprises a cavity, at least one base locking element, a recess comprising a recess void and an illumination assembly in the cavity wherein the illumination assembly comprises an illuminator capable of emitting light. The back plate is reversibly mountable on the base and preferably comprises an engraving which is preferably painted. The back plate comprises at least one back plate locking element. The back plate locking element is reversibly engageable with the base plate locking element. A tab is provided on the back plate which is receivable by the recess. The tab comprises a tab void which is alignable with the recess void. An illumination window in the back plate allows light to transmit through the illumination window. The back plate also comprises at least one securing recess. The bezel is reversibly mountable on the back plate. The bezel comprises a viewing window and a securing tab wherein the securing tab is received by the securing recess. A locking element extends through the aligned tab void and recess void.

### BRIEF DESCRIPTION OF DRAWINGS

FIG. 1 is a schematic perspective view of an embodiment of the invention.

FIG. 2 is a schematic partially exploded perspective view of an embodiment of the invention.

FIG. 3 is a schematic exploded perspective view of a back plate and bezel of the invention.

FIG. 4 is a schematic partially exploded perspective view of an embodiment of the invention.

FIG. 5 is a schematic back view of an embodiment of the invention.

### DESCRIPTION

The present invention is specific to a wearable article capable of having mounted thereto a translucent stone wherein the translucent stone is backlit from within the wearable article. More specifically, the present invention is related to a wearable article comprising a base with a backplate secured to the base and bezel secured to the backplate with a translucent stone secured between the bezel and backplate.

The stone is not limited herein, however, the advantages offered by the invention are more readily appreciated with stones that are translucent or semi-transparent. Particularly preferred are natural precious or semi-precious stones and gems either as they occur naturally or as cut to expose facets and faces. Natural materials such as diamonds, rubies, sapphires, emeralds, amazonites, ambers, amethysts, ametrines, apatites, fluorites, pyrites, fuchsites, pyropes, almandines, garnets, rhodochristes, rubellites, azurites, hawks eyes, serpentines, agates, chalcedonies, iolites, jades, citrines, kunzites, tourmalines, corals, kyanites, verdites, larimars, diaspores, modavite, quartzes, zirconiums, and combinations thereof are suitable for demonstration of the invention. Synthetic stones are also suitable for demonstration of the invention.

The invention will be described with reference to the figures which are an integral, but non-limiting, part of the specification provided for clarity of the invention. Throughout the various figures similar elements will be numbered accordingly.

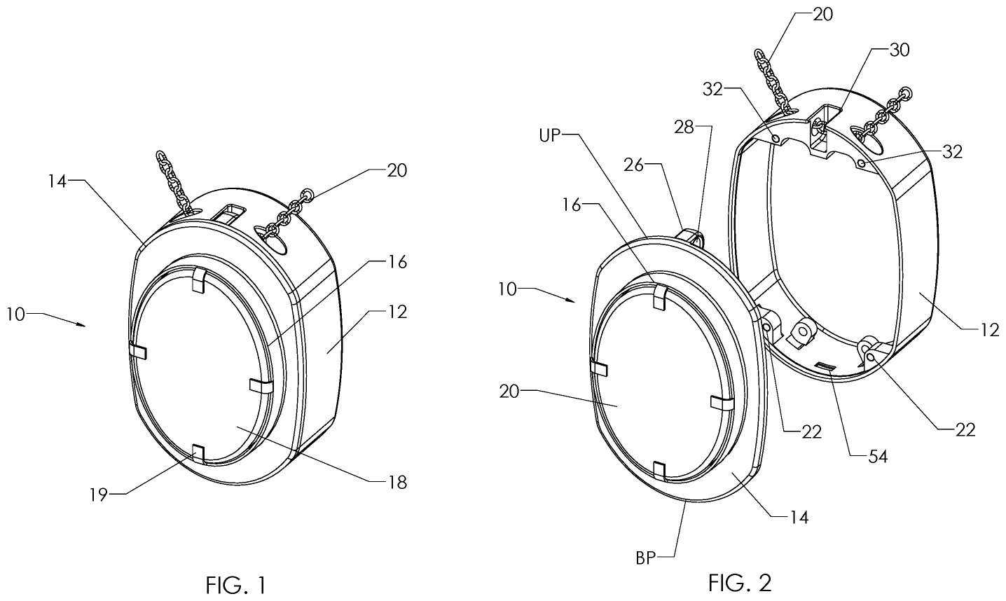

An embodiment of the invention will be described with reference to FIG. 1 wherein a wearable device of the invention is illustrated in schematic perspective view. In FIG. 1, the wearable device, 10, comprises a cavernous base, 12, with a backplate, 14, secured to the open end of the base. A bezel, 16, is reversibly attached to the backplate wherein the bezel and backplate secure a translucent stone, 18, between the bezel and backplate. A locking element, 20, secures the backplate to the base as will be realized from further description herein. Stone anchors, 19, which are preferably integral to the bezel, 16, engage with the stone to ensure the stone is incapable of traversing through the viewing window of the bezel.

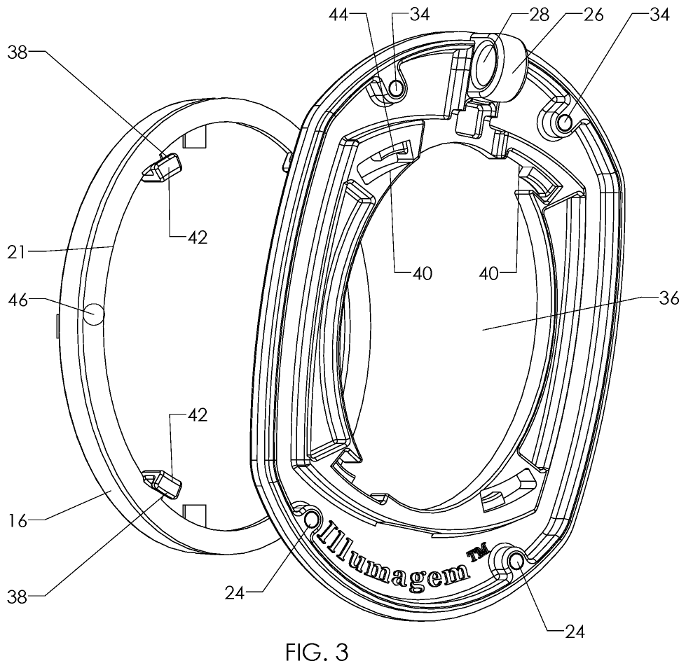

An embodiment of the invention will be described with reference to FIG. 2 wherein the wearable device is illustrated in partial exploded schematic view. In FIG. 2, the cavernous base, 12, comprises at least one base locking element, 22, which functions in concert with a back plate locking element, not shown, to secure the back plate to the base. Particularly preferred as a base locking element and a back plate locking element are mating magnets. Mating magnets are known to form a strong bond with regards to pulling two items away perpendicular to the faces of the mating magnets. Mating magnets do not form a strong bond against rotational separation. By way of example, and with reference to FIG. 2, if the back plate is drawn away from the base perpendicular to the plane of the back plate mating magnets form a strong bond. If the back plate is withdrawn at an angle, with the upper portion, UP, drawn away more rapidly than the bottom portion, BP, the back plate can be more easily removed. A primary locking mechanism is provided opposite the mating magnets of the back plate locking element and base locking element wherein the primary locking mechanism comprises a tab, 26, on the back plate with a tab void, 28, in the tab. The tab is received in a recess, 30, of the base. A recess void, 32, in the recess, 30, aligns with the tab void, 28, thereby allowing a locking element, 20, to be received through the aligned recess void and tab void. The locking element inhibits rotation of the back plate, relative to the base, thereby maximizing the bond strength provided by the mating magnets of the back plate locking element and base locking element. It is preferable that the back plate locking element and base locking element be disposed away from the recess void to increase the resistance required to remove the back plate from the base. At least one secondary back plate locking element, 32, and at least one secondary base locking element, 34, can be disposed near the recess. A switch cavity, 54, allows a power switch to be accessible from the exterior as will be more fully realized after further description. Other cavities may be employed to access the interior such as for the purposes of charging the batteries or altering the light.

An embodiment of the invention will be discussed with reference to FIG. 3 wherein a back plate, 14, and bezel, 16, are illustrated schematically in exploded view. The back plate has an illumination window, 36, preferably centrally located wherein light passes to expose the illumination window and illuminates the stone. The light transmitted through the stone passes through the viewing window, 21, of the bezel. Securing tabs, 38, of the bezel, are received by securing recesses, 40, in the back plate. In a particularly preferred embodiment, each securing tab comprises at least one foot, 42, which mate with ledges, 44. In an embodiment the bezel and back plate are mated in a first rotational orientation with the securing tabs entering into the securing recesses with the feet not engaged with the ledges. After mating the bezel is rotated to a second rotational orientation wherein the feet of the securing tabs engage with the ledges of the securing recesses thereby securing the bezel and backplate in an engaged relationship. Optional, but preferred, mating locks, 46, such as mating magnets, on the bezel and back plate inhibit unintended rotation back to the first rotational orientation.

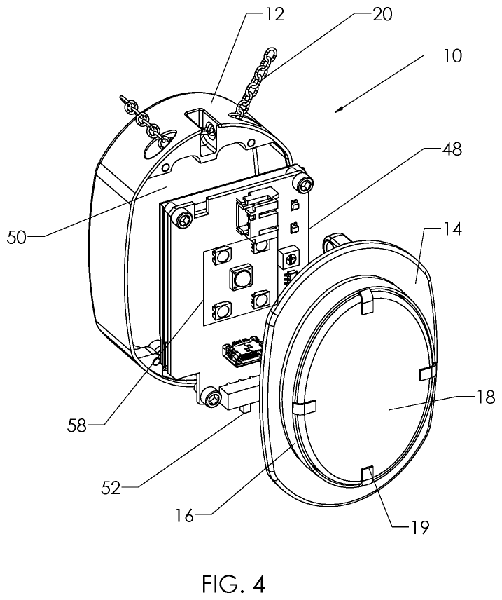

An embodiment of the invention will be described with reference to FIG. 4 wherein a wearable device is illustrated in schematic partially exploded view. In FIG. 4 an illumination assembly, 48, is illustrated wherein the illumination assembly is received in the cavity, 50, of the base, 12. The electrical details of the illumination assembly are not particularly limited herein with suitable illumination assemblies being readily obtained commercially from a variety of sources that can be custom made to meet the limitations of size. Preferred in the illumination assembly is a power switch, 52, preferably extending through a switch cavity, 54, in the base as more easily seen in FIG. 2. The illumination assembly preferable utilizes batteries, and preferably rechargeable batteries, as a power source and it is particularly preferable that the illumination assembly comprise recharge functionality and connectivity to allow the batteries to be recharged without removal. At least one illuminator, and preferably multiple illuminators, 56, are preferably arranged to provide equal illumination over the entirety of the stone or the entirety of the illumination window. Alternatively, a diffuser, 58, may be incorporated into the illuminators, or between the illuminators and illumination window to diffuse light thereby insuring equal illumination across the illumination window. Alternatively, the illuminators may be adjustable or programmable remotely, locally or automatically. The illuminators are not particularly limited however light emitting diodes (LED's) are preferred due to the low energy consumption, small size, low cost, high output and minimal heat generation. The LED may emit visible light, ultraviolet light or combinations thereof thereby allowing any fluorescence of phosphorescence in the stone to be displayed.

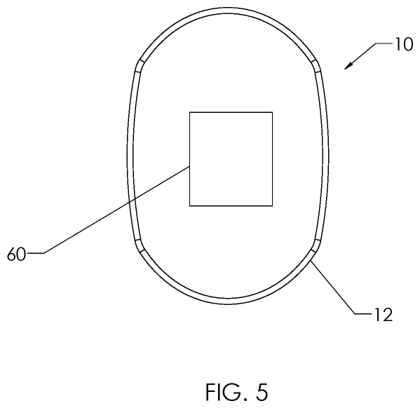

An embodiment of the invention will be described with reference to FIG. 5 wherein the back of a wearable device is illustrated schematically. In FIG. 5 the wearable device, 10, comprises an auxiliary mount, 60, wherein the auxiliary mount allows the wearable device to be incorporated into a mount suitable for use as an article of jewelry, incorporated into an article of clothing, or as an attire accessory. In particularly preferred embodiments the auxiliary mount represents a finger ring, an ear ring, a button, a hair accessory, a hat accessory, a clasp, a pin and pin retainer such as for a broach, a pendant, a portion of a hook and latch attachment such as VELCRO®, or combinations thereof.

The locking element is a, preferably elongated and preferably flexible, element that is capable of being inserted through the aligned recess void and tab void to inhibit the back plate from withdrawing away from the base. The locking element may have aesthetic utility. In a preferred embodiment the locking element has alternate functionality such as functioning as a lanyard or necklace such that the wearable device can be worn around the neck as a pendant. Particularly preferred locking mechanisms comprise; chains, preferably of precious metal; string; leather; cloth; wire and the like.

The stone anchor is a protrusion from the bezel which secures the stone and inhibits the stone from transiting through the viewing window of the bezel. The stone anchor is not particularly limited herein and any structure capable of securing the stone within the bezel is suitable for demonstration. Particularly preferred for demonstration of the invention are prongs. In another embodiment multiple stone anchors may be taken together to represent wire wrap wherein the wire wrap can traverse across a major portion of the stone or across a small portion of the stone. It is preferable that the stone anchor does not significantly impair visibility of the stone.

The material of construction is not particularly limited herein with the understanding that it is preferred that the wearable device, and stone, be low weight and aesthetically pleasing. Particularly preferred materials include precious metals and alloys of precious metals with silver and silver alloys being particularly preferred due to their aesthetic appeal, structural characteristics, ease of formation and cost.

In an embodiment the backplate will have engravings around the stone preferable with a paint, and more preferably a black fluorescent paint in a variety of patterns. A particularly preferred paint is a black ultraviolet (UV) reactive paint which can be used to form an image, or embellish an engraved pattern, on the backplate. A fluorescent or phosphorescent paint is particularly preferred with a particular preference for a paint which can absorb light; such as sunlight, a blacklight or a UV light; for display of a color; such as green, blue, red, orange or yellow; or a black image.

The paint can be a mixture of fluorescent pigment, fluorescent powder or a fluorescent liquid, in a black paint. A mixture of 15 wt % to 30 wt % fluorescent pigment, powder or a liquid in black paint is suitable for demonstration of the invention. A particularly suitable paint for demonstration of the invention is black 3.0 black paint available at culturehustle.com. Fluorescent pigment, powder or a liquid resin is available at tehnoglowproducts.com.

The invention has been described with reference to preferred embodiments without limit thereto. One of skill in the art would realize additional embodiments which are described and set forth in the claims appended hereto.

Claimed is:

1. A wearable device comprising:
a base comprising:
a cavity;
at least one base locking element;
a recess comprising a recess void; and
an illumination assembly in said cavity wherein said illumination assembly comprises an illuminator capable of emitting light;
a back plate reversibly mountable on said base wherein said base plate comprises:
at least one back plate locking element wherein said back plate locking element is reversibly engageable with said base plate locking element;
a tab receivable by said recess wherein said tab comprises a tab void alignable with said recess void;
an illumination window wherein said light transmits through said illumination window;
at least one securing recess; and
an engraving comprising a paint;
a bezel reversibly mountable on said back plate wherein said bezel comprises:
a viewing window; and
a securing tab wherein said securing tab is received by said securing recess; and
a locking element extending through aligned said tab void and said recess void.

2. The wearable device of claim 1 further comprising a stone secured between said bezel and said back plate and capable of transmitting said light from said illumination window through said viewing window.

3. The wearable device of claim 2 wherein said stone is selected from the group consisting of diamond, ruby, sapphire, emerald, amazonite, amber, amethyst, ametrine, apatite, fluorite, pyrite, fuchsite, pyrope, almandine, garnet, rhodochriste, rubellite, azurite, hawks eye, serpentine, agate, chalcedonie, iolite, jade, citrine, kunzite, tourmaline, coral, kyanite, verdite, larimar, diaspore, modavite, quartz, zirconium, and combinations thereof.

4. The wearable device of claim 1 wherein said bezel further comprises at least one stone anchor.

5. The wearable device of claim 4 wherein said stone anchor is selected from the group consisting of a prong and a wire wrap.

6. The wearable device of claim 1 wherein said base locking element and a back plate locking element are mating magnets.

7. The wearable device of claim 1 wherein said securing tab comprises at least one foot and said securing recess comprise a ledge wherein in a first rotational orientation of said bezel relative to said back plate said foot and said ledge does not engage and in a second rotational orientation of said bezel relative to said back plate said foot and said ledge do engage.

8. The wearable device of claim 1 further comprising a diffuser.

9. The wearable device of claim 1 wherein said illuminator is a light emitting diode.

10. The wearable device of claim 1 wherein said locking element is selected from the group consisting of a chain, a string, leather, cloth and wire.

11. The wearable device of claim 1 further comprising an auxiliary mount.

12. The wearable device of claim 11 wherein said auxiliary mount is selected from the group consisting of a finger ring, an ear ring, a button, a hair accessory, a hat accessory, a clasp, a pin and pin retainer, a pendant, a portion of a hook and latch attachment or combinations thereof.

13. The wearable device of claim 1 wherein said paint is a black paint.

14. The wearable device of claim 13 wherein paint comprises a fluorescent pigment, fluorescent powder or fluorescent liquid.
